(19) United States
(12) Patent Application Publication
(10) Pub. No.: US 2022/0053038 A1
(43) Pub. Date: Feb. 17, 2022

(54) ONLINE MEDIATION AND SETTLEMENT OF DISUPTES

(71) Applicant: DISPUTECH IP HOLDCO PTY LTD, Richmond, Victoria (AU)

(72) Inventors: Claire Bibby, Richmond, Victoria (AU); Laure Keily, Richmond, Victoria (AU)

(21) Appl. No.: 17/433,882

(22) PCT Filed: Feb. 27, 2020
(86) PCT No.: PCT/IB2020/051662

§ 371 Date: Aug. 25, 2021

(30) Foreign Application Priority Data
Feb. 27, 2019 (AU) 2019900615
Sep. 13, 2019 (AU) 2019903425

(51) Int. Cl. H04L 29/06; G06F 40/30; G06F 3/0484; H04L 12/58

(52) U.S. Cl. CPC H04L 65/403; H04L 51/16; G06F 3/04842; G06F 40/30

(57) ABSTRACT

A computer-implemented method of mediating and settling a dispute, the method comprising: establishing a video conference session between participants in a mediation of the dispute, wherein the video conference session comprises a video stream, an audio stream, and an information stream, wherein the information stream comprises one or both of: a chat stream between some or all of the participants to display and receive chat messages relating to the mediation of the dispute, a term drafting stream to display and receive user text input from one of the participants relating to draft terms of settlement of the dispute.

### FIELD

The present invention relates to online mediation and settlement of disputes.

### BACKGROUND

Disputes are conventionally mediated by an expert mediator in person between parties to the dispute and their legal representatives.

Conventional in-person mediations suffer from various drawbacks. They require all participants—usually the disputing parties, their lawyers and a mediator—to be physically present in the same location. Consequently, they are costly and complicated to organise and conduct.

A need therefore exists for improved solutions for mediation and settlement of disputes.

### SUMMARY

According to the present invention, there is provided a computer-implemented method of mediating and settling a dispute, the method comprising:

establishing a video conference session between participants in a mediation of the dispute, wherein the video conference session comprises a video stream, an audio stream, and an information stream;

wherein the information stream comprises one or both of:
a chat stream between some or all of the participants to display and receive chat messages relating to the mediation of the dispute;
a term drafting stream to display and receive user text input from one of the participants relating to draft terms of settlement of the dispute.

The participants may comprise a mediator, disputing parties and representatives of the disputing parties, wherein the video stream, audio stream and chat stream are each selectively controlled by the mediator.

The term drafting stream may be controlled by the mediator or one of the participants selected by the mediator.

The method may further comprise generating a settlement agreement based on the user text input of draft terms of settlement displayed and received via the term drafting stream during the video conference session.

The method may further comprise presenting user selectable options relating to signature blocks of the settlement agreement.

The method may further comprise automatically generating valid signature blocks for the settlement agreement using user selected options.

The user selectable options relating to the signature blocks may be presented as dropdown options corresponding to fields of the signature blocks.

The method may further comprise receiving electronic signatures of the settlement agreement from the disputing parties during the video conference session.

The video stream may comprise videos displayed simultaneously in separate adjacent windows or in one or more inset windows inside a larger window.

The information stream may comprise text displayed simultaneously in overlapping tabbed text boxes adjacent to the windows of the video stream.

The information stream may further comprise one or more of a summary of the dispute, and electronic documents relating to the dispute.

The method may further comprise automatically deleting or disabling the electronic documents relating to the dispute after settlement.

The method may further comprise, after settlement, automatically generating one or more invoices for one or more fees payable by one or more of the disputing parties, or payable to the mediator, for providing the mediation of the dispute.

The present invention also provides a system for mediating and settling a dispute, the system comprising:

a memory to store instructions; and

one or more processors to execute instructions stored in the memory to:
establish a video conference session between participants in a mediation of the dispute, wherein the video conference session comprises a video stream, an audio stream, and an information stream;
wherein the information stream comprises one or both of:
   a chat stream between some or all of the participants to display and receive chat messages relating to the mediation of the dispute;
   a term drafting stream to display and receive user text input from one of the participants relating to draft terms of settlement of the dispute.

The present invention further provides a computer program product comprising computer readable instructions which, when loaded onto a computer, configures the computer to perform the method described above.

### BRIEF DESCRIPTION OF DRAWINGS

Embodiments of the invention will now be described by way of example only with reference to the accompanying drawings, in which:

FIG. 1 is a flow chart of a method of mediating and settling a dispute according to an embodiment of the present invention; and

FIGS. 2 to 24 are example user interfaces (UIs) and electronic documents generated by the method of FIG. 1.

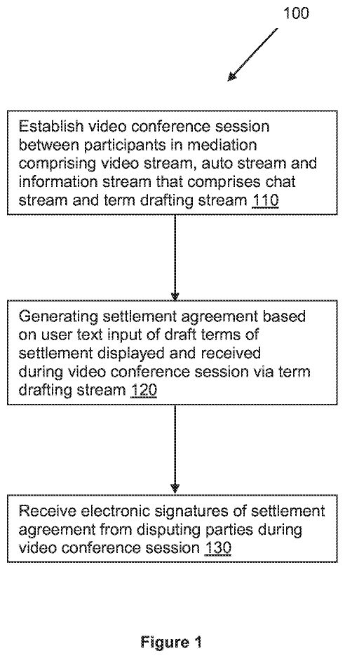

### DESCRIPTION OF EMBODIMENTS

Referring to the drawings, a computer-implemented method 100 of mediating and settling a dispute according to an embodiment of the present invention may start at step 110 by establishing a video conference session 200 between participants in a mediation of the dispute. The video conference session 200 may generally comprise a video stream 210, an audio stream 220, and an information stream 230. The term “stream” refers to video, audio and text content that may be viewed, heard and read/input directly over the internet in real-time or near real-time without having to be downloaded onto a computer device first.

The information stream 230 may comprise a chat stream 240 between some or all of the participants to display and receive chat messages relating to the mediation of the dispute. Further or alternatively, the information stream 230 may comprise a term drafting stream 250 to display and receive user text input from one of the participants relating to draft terms of settlement of the dispute. Optionally, the information stream 230 may further comprise one or more of a summary of the dispute, and electronic documents relating to the dispute.

The participants may comprise a mediator, disputing parties and representatives of the disputing parties. The video stream 210, audio stream 220 and chat stream 240 may each be selectively controlled by the mediator. For example, the mediator may selectively control the video stream 210 and audio stream 220 during the video conference session 200 to place selected disputing parties and/or their representatives into private rooms, and/or selectively mute selected participants, to facilitate online mediation of the dispute.

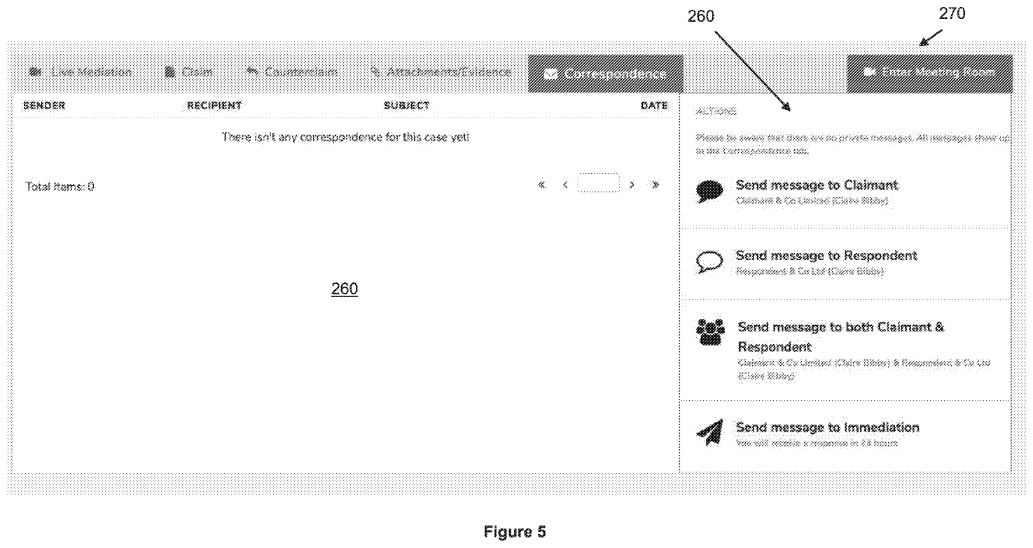

Referring to FIG. 5, the method 100 may optionally further comprise providing internal messaging 260, such as internal emails, between the participants. A user selectable tab 270 may be also provided to enable two or more of the participants to enter a virtual meeting room that is offline from the live online mediation. This meeting room may be used for preliminary meetings, introductions of the participants, pre-mediation conferences, break-out meetings, etc. The meeting room may be provided as a ‘lite’ version of the features and functions of the ‘pro’ version of the video conference session 200 that is provided for actual online mediation of the dispute.

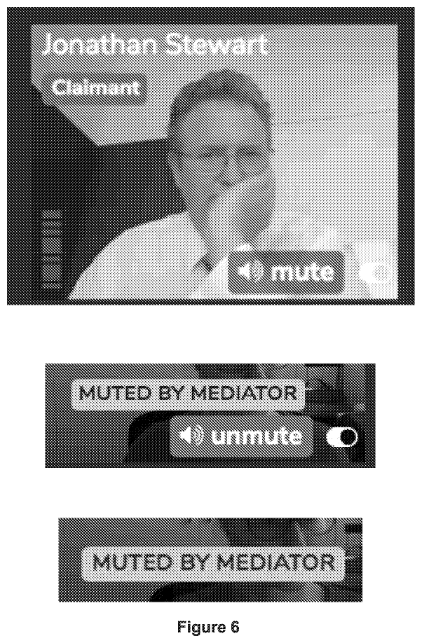

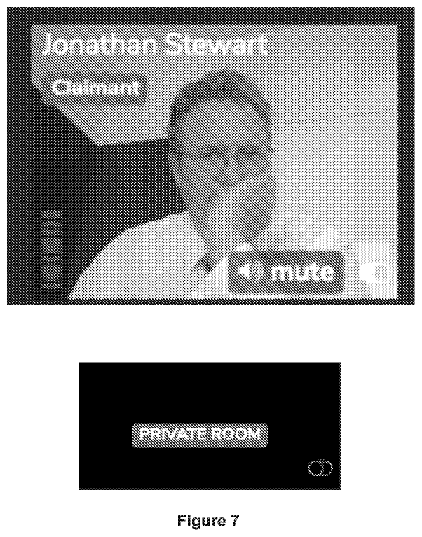

The mediator may be provided with additional powers, features and functions to control and facilitate the online mediation, for example, by selectively force muting one or more of the disputing parties and/or their representatives, and/or placing one or more of the disputing parties and/or their representatives in one or more virtual private rooms. FIG. 6 illustrates example UIs generated by the method 100 when the mediator force mutes and unmutes a claimant, Jonathan Stewart. FIG. 7 illustrates example UIs generated by the method 100 when the mediator places the same claimant into a virtual private room that is offline from the online live mediation.

The term drafting stream 250 may be controlled by the mediator or one of the participants selected by the mediator, for example, a representative of one of the disputing parties who is chosen to be a “scribe.”

The video stream 210 and audio stream 220 may comprise videos and audios displayed/played simultaneously in separate adjacent windows or in one or more inset windows inside a larger window. The information stream 230 may comprise text displayed/input simultaneously in overlapping tabbed text boxes adjacent to the windows of the video stream 210 and audio stream 220.

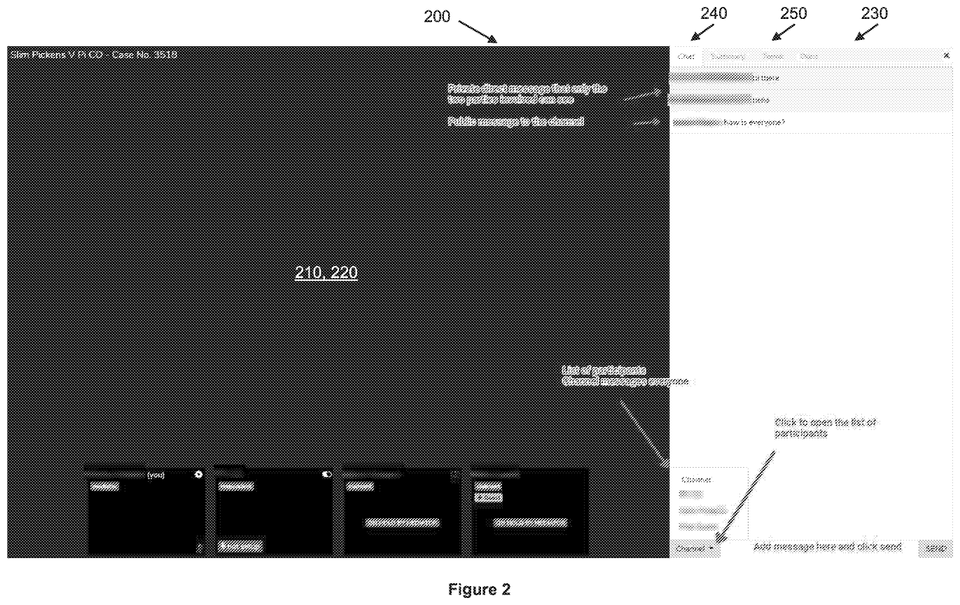

Referring to FIG. 2, the chat stream 240 may display direct chat messages between some or all of the participants in text boxes to facilitate mediation of the dispute. The chat messages may comprise public or private chat messages. A list of participants in each of the public or private channels of chat messages may be displayed in a text box below the chat messages.

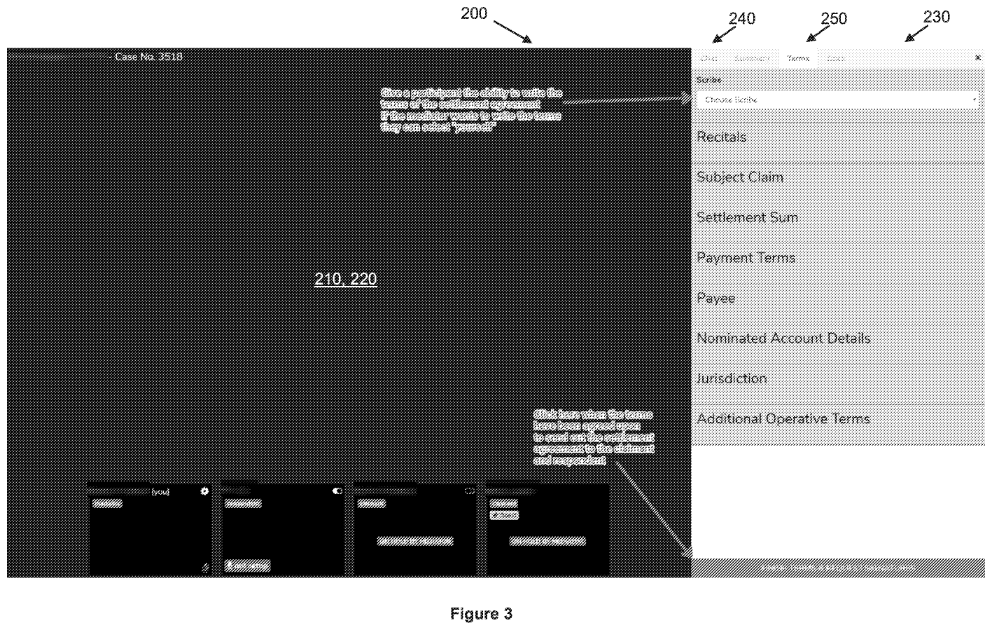

Referring to FIG. 3, the term drafting stream 250 may display clause headings of draft terms of a settlement agreement. The clause headings may, for example, comprise “Recitals,” “Subject Claim,” “Settlement Sum,” “Payment Terms,” “Payee,” “Nominated Account Details,” Jurisdiction,” and “Additional Operative Terms.” The name of the scribe chosen by the mediator to the provide user text input relating to the draft terms of settlement may be displayed in a text box above the clause headings.

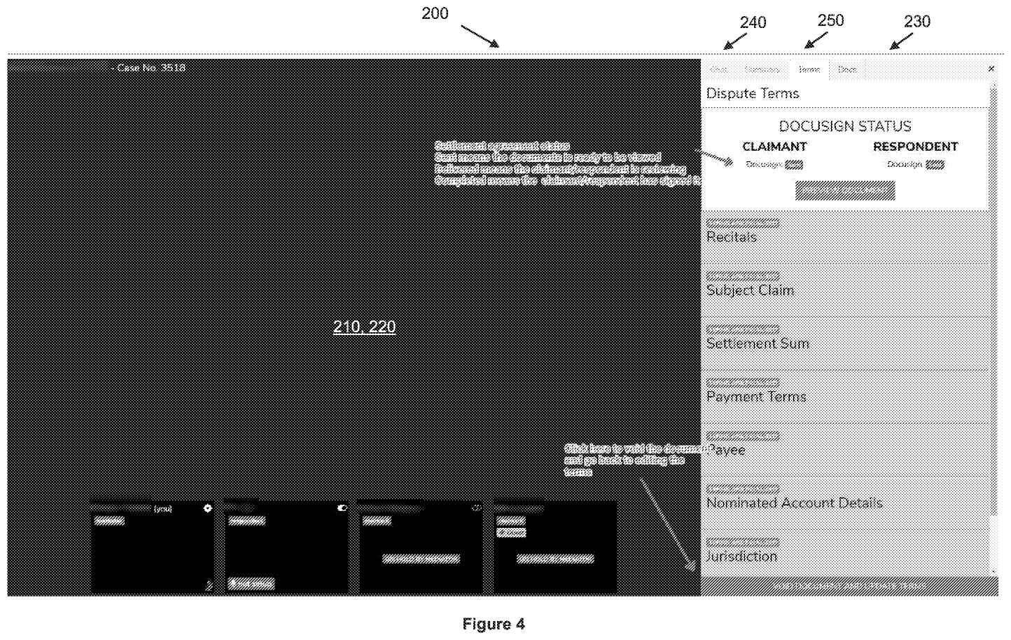

Referring to FIG. 4, the method 100 may move to step 120 where a settlement agreement of the dispute is generated based on the user text input of finalised terms of settlement displayed and received via the term drafting stream 250 during the video conference session 200.

Optionally, the method 100 may further comprise presenting user selectable options relating to signature blocks of the settlement agreement. Valid, or legally compliant, signature blocks for the settlement agreement may then be automatically generated using the user selected options. The user selectable options relating to the signature blocks may, for example, be presented as dropdown options corresponding to fields of the signature blocks. The user selected options corresponding to the fields may be positioned in the signature block before or after the electronic signature field.

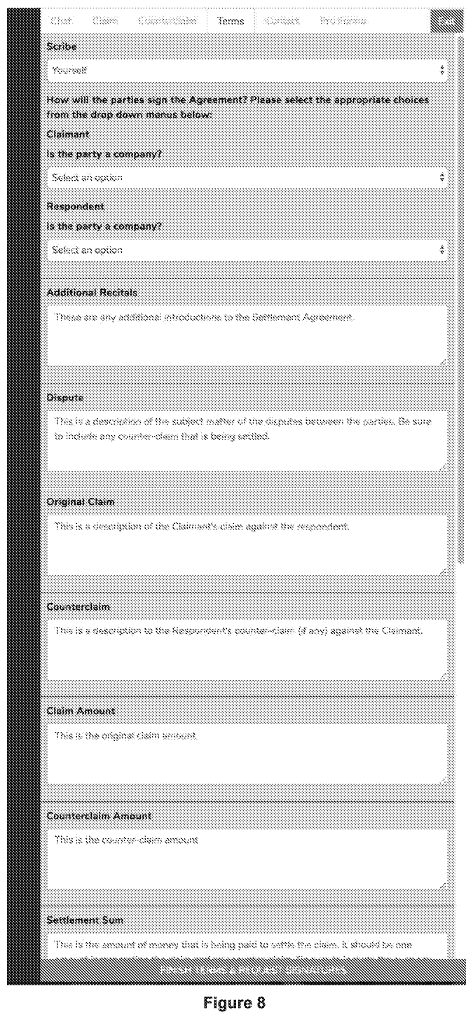

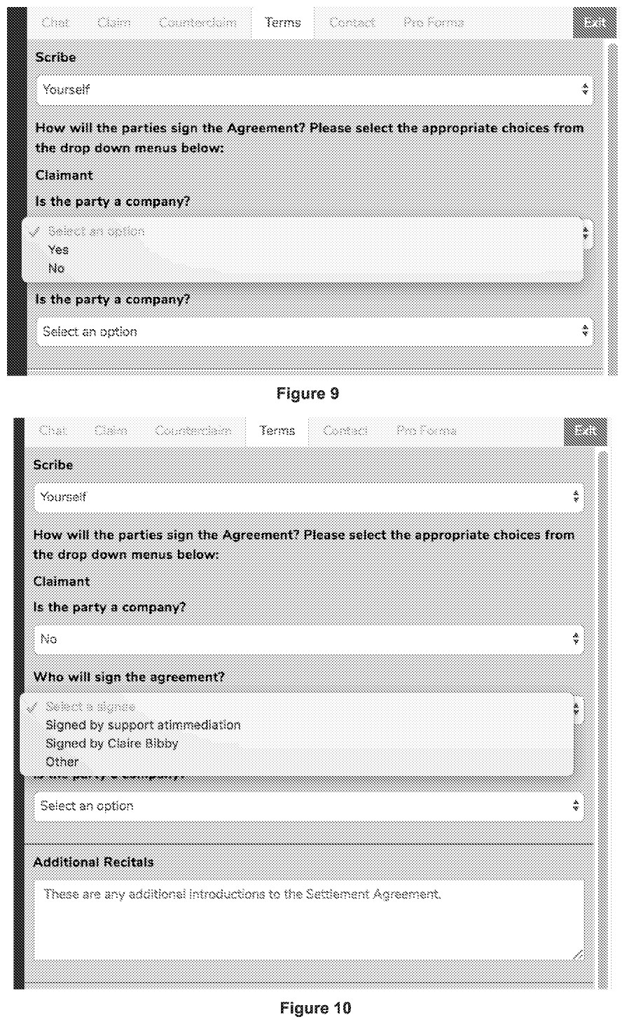

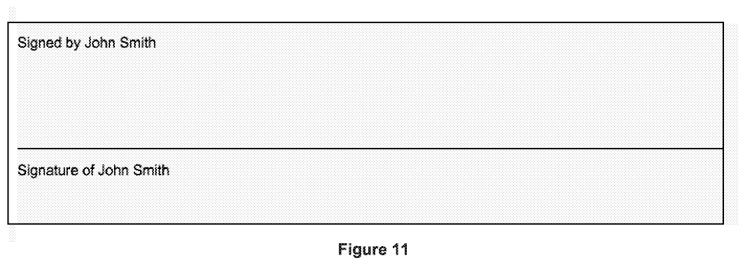

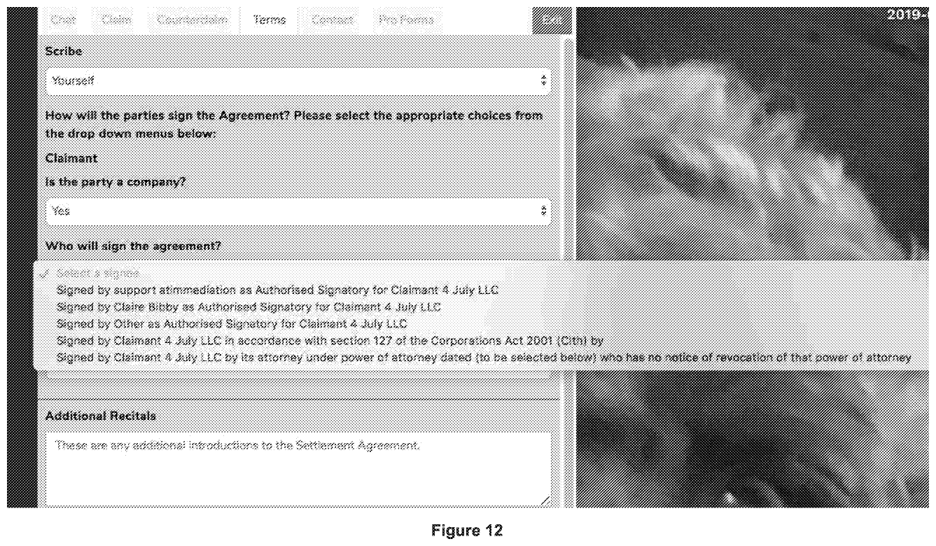

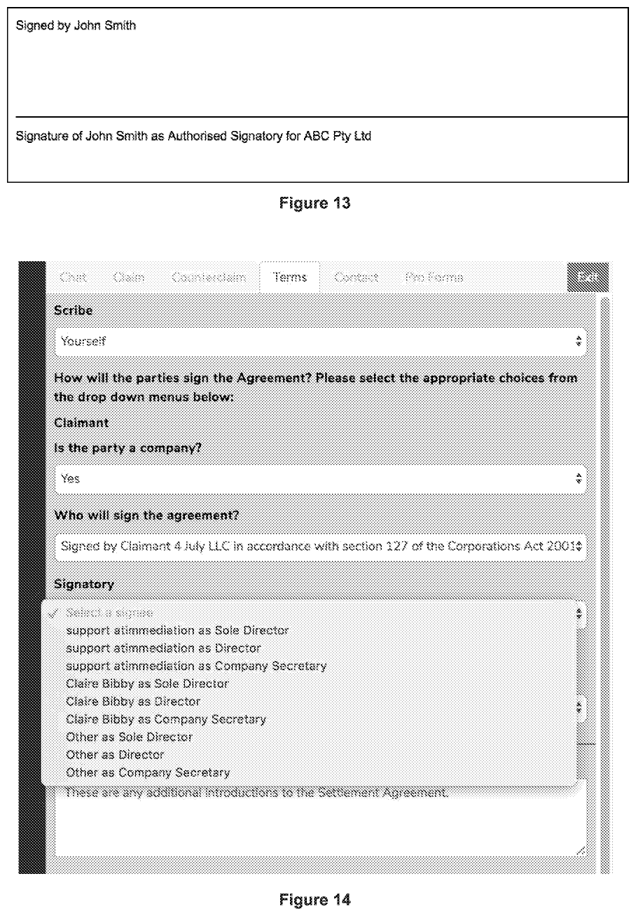

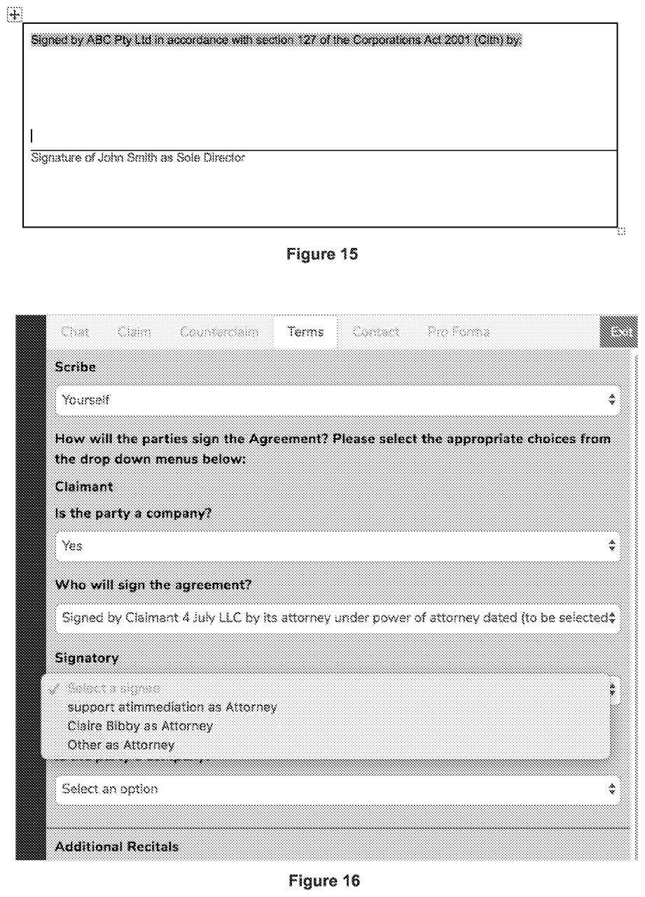

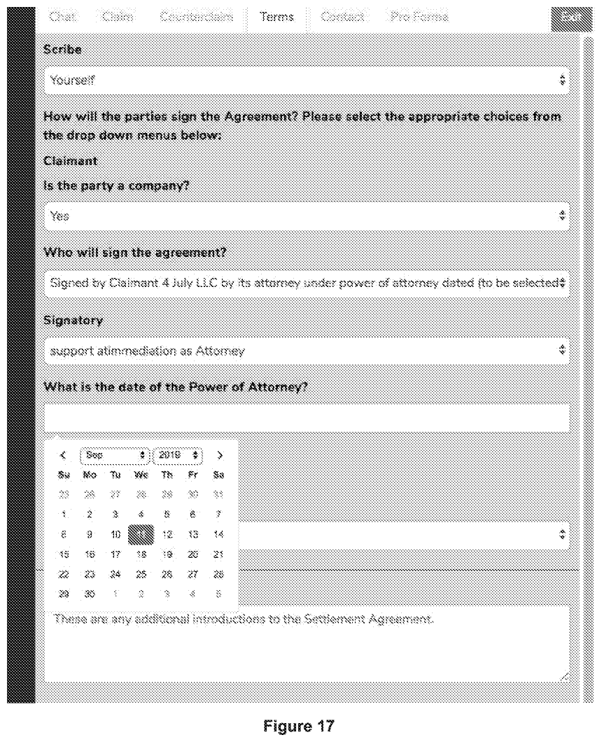

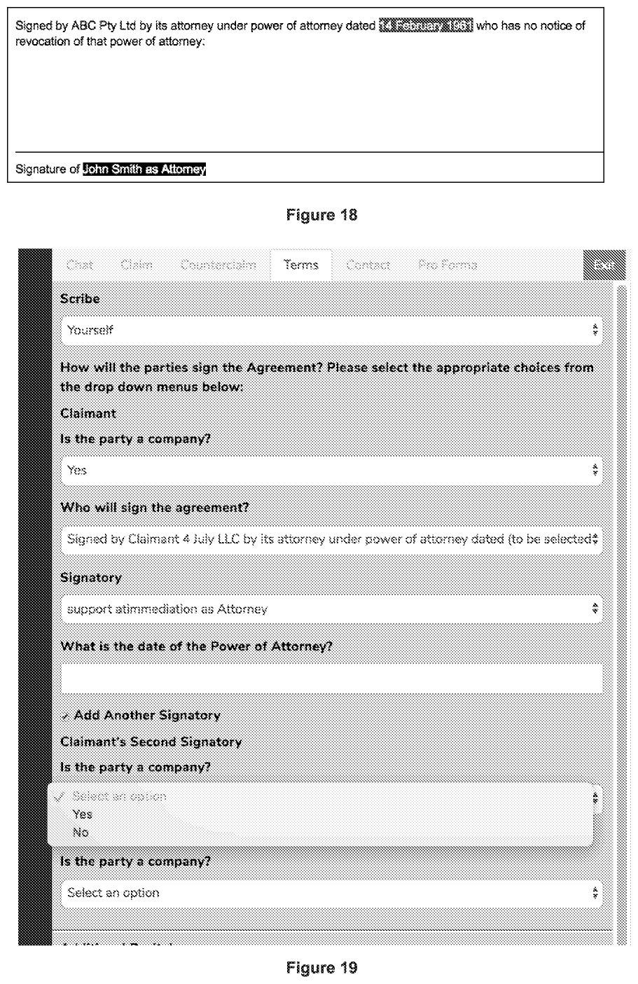

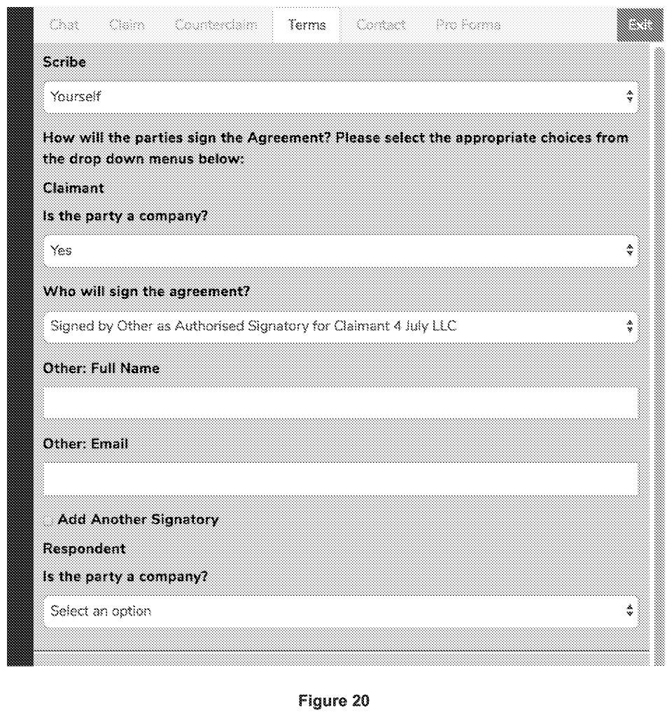

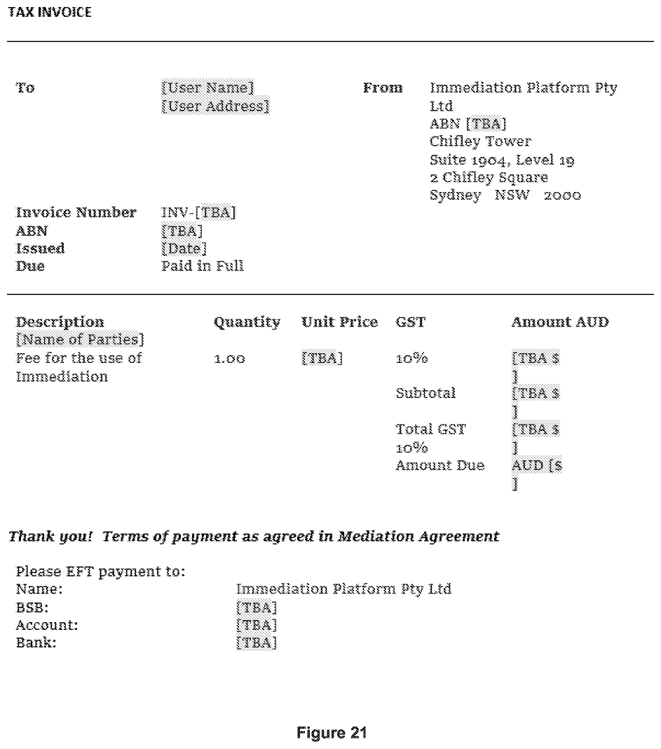

FIGS. 8 to 20 illustrate examples dropdown menu options for generating signature blocks for individual and company signing parties (or signees or signatories) based on user selection of options from dropdown menus. The dropdown menus may, for example, comprise user selectable options for fields of the signature blocks, such as whether each signee is an individual or a company, as illustrated in FIGS. 8 to 10. If the signee is a company, further user selectable options for single or multiple corporate signatories may be presented as illustrated in FIGS. 12, 14, 16, 17, 19, and 20, such as whether the signees are two directors of a company, one director and one company secretary, sole director who is also the company secretary, an attorney of the company under a power of attorney, etc. FIGS. 11, 13, 15, and 18 are example signature blocks for the settlement agreement that are automatically generated using the user selected options from the dropdown menus of FIGS. 8 to 10, 12, 14, 16, 17, 19, and 20. Other alternative or equivalent user selectable options relating to the signature blocks may be presented based on specific legal jurisdictions where the settlement agreement is being signed. The automatically generated signature blocks may be inserted into the execution clauses of the settlement agreement that was previously generated using the term drafting stream 250. The settlement agreement populated with the valid signature blocks may then be emailed to the respective signees of the disputing parties for signing using electronic signatures.

The method 100 may end at step 130 by receiving electronic signatures of the settlement agreement from the disputing parties during the video conference session 200. The electronic signatures may, for example, be received via an electronic signature application, such as DocuSign®.

The method 100 may optionally further comprise, after settlement, automatically generating one or more invoices for one or more fees payable by one or more of the disputing parties, or payable to the mediator, for providing the mediation of the dispute. Before the online mediation starts, payment information, such as credit card details, may be entered by the disputing parties. This payment information may be used to automatically generate one or two invoices for the cost of the online mediation, depending on whether one disputing party is paying for the online mediation, or both disputing parties are sharing the cost. FIG. 21 illustrates an example tax invoice for the cost of the online mediation that is automatically generated and issued to the one or both of the disputing parties.

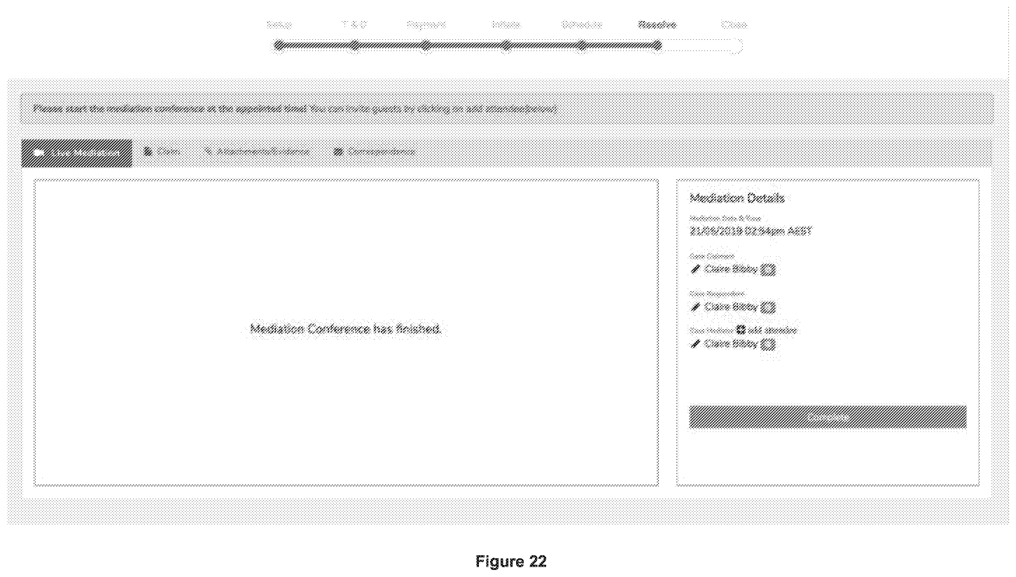

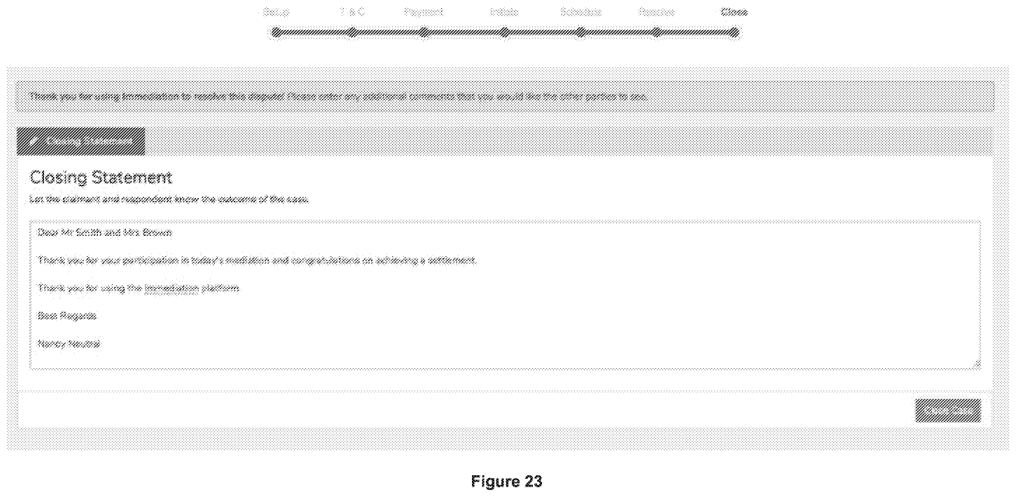

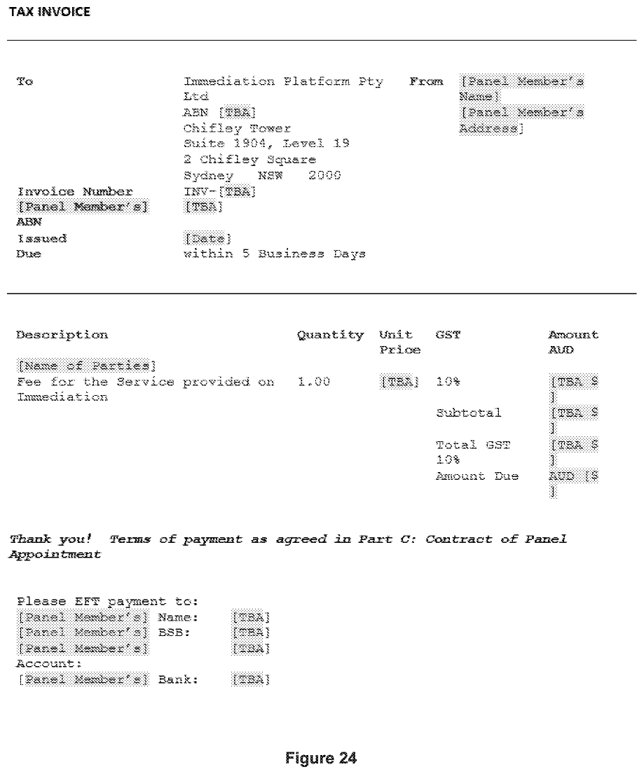

FIGS. 22 and 23 are example user interfaces presented to the mediator to write a closing statement after the online mediation has been completed. The online platform may then automatically generate an invoice from the mediator to the provider of the online mediation platform for the mediator's service fee for conducting the online mediation. FIG. 24 is an example tax invoice for the mediator's service fee for the online mediation that is automatically generated and issued to the provider of the online mediation platform.

The method 100 may optionally also comprise automatically deleting or disabling electronic documents relating to the dispute after settlement. The electronic documents may include primary electronic documents uploaded by participants to the mediation of dispute, as well as secondary documents generated during or for the mediation, such as dispute summaries and settlement agreements.

The automatic deletion of electronic documents may, for example, be performed by storing meta data alongside each uploaded or generated electronic document that contains a deletion or self-destruction date. The backend servers that control the storage of the electronic documents may periodically scan this meta data for when a date passes, and if the deletion date for an electronic document has expired, then it is deleted from storage.

Further or alternatively, the electronic documents may be automatically disabled and/or overwritten by, for example, wrapping the electronic document in a PDF that contains an auto-executing scripted sub-component which triggers a white-on-white font change (that is not visible to a recipient) and removes text selection. This may provide an additional layer of electronic security should the electronic document be downloaded from the online platform, as it will still be rendered unusable to ensure sensitive or confidential information relating to the dispute remains protected.

The method 100 may be implemented in client/server/database network system as a mediation and settlement software application executing on client computing devices such as tablet, laptop or desktop computers. The mediation and settlement application may be implemented as a web application as software as a service (SaaS), or as a web service.

The mediation and settlement application may comprise a video conference application comprising a chat module and a term drafting module. An electronic signature application, such as DocuSign®, may interface to the mediation and settlement application via an application programming interface (API).

Embodiments of the present invention provide a computer-implemented method and related online platform that are both specifically and generally useful for online mediation and settlement of disputes.

For the purpose of this specification, the word “comprising” means “including but not limited to,” and the word “comprises” has a corresponding meaning.

The above embodiments have been described by way of example only and modifications are possible within the scope of the claims that follow.

1. A computer-implemented method of mediating and settling a dispute, the method comprising:
establishing an online mediation session between participants in a mediation of the dispute, wherein the online mediation session comprises a video stream, an audio stream, and an information stream that comprises;
a chat stream between some or all of the participants to display and receive chat messages relating to the mediation of the dispute;
a term drafting stream to display and receive user text input from one of the participants relating to draft terms of settlement of the dispute:,
during the online mediation session, generating a settlement agreement based on the user text input relating to draft terms of settlement received via the term drafting stream;
during the online mediation session, presenting user selectable options relating to signature blocks of the settlement agreement; and
during the online mediation session, automatically generating valid signature blocks for the settlement agreement using the user selected options.

2. The method of claim 1, wherein the participants comprise a mediator, disputing parties and representatives of the disputing parties, and wherein the video stream, audio stream and chat stream are each selectively controlled by the mediator.

3. The method of claim 1, wherein the term drafting stream is controlled by the mediator or one of the participants selected by the mediator.

4. (canceled)

5. The method of claim 1, further comprising receiving electronic signatures of the settlement agreement from the disputing parties during the online mediation session.

6. The method of claim 1, wherein the video stream comprises videos displayed simultaneously in separate adjacent windows or in one or more inset windows inside a larger window.

7. (canceled)

8. (canceled)

9. The method of claim 1, wherein the user selectable options relating to the signature blocks are presented as dropdown options corresponding to fields of the signature blocks.

10. The method of claim 1, wherein the information stream comprises text displayed simultaneously in overlapping tabbed text boxes adjacent to windows of the video stream.

11. The method of claim 1, wherein the information stream further comprises one or more of a summary of the dispute, and electronic documents relating to the dispute.

12. The method of claim 11, further comprising automatically deleting or disabling the electronic documents relating to the dispute after settlement.

13. The method of claim 1, further comprising, after settlement, automatically generating one or more invoices for one or more fees payable by one or more of the disputing parties, or payable to the mediator, for providing the mediation of the dispute.

14. A system for mediating and settling a dispute, the system comprising:
a memory to store instructions; and
one or more processors to execute instructions stored in the memory to:
establish an online mediation session between participants in a mediation of the dispute, wherein the online mediation session comprises a video stream, an audio stream, and an information stream that comprises;
a chat stream between some or all of the participants to display and receive chat messages relating to the mediation of the dispute;
a term drafting stream to display and receive user text input from one of the participants relating to draft terms of settlement of the dispute:,
during the online mediation session, generate a settlement agreement based on the user text input relating to draft terms of settlement received via the term drafting stream;
during the online mediation session, present user selectable options relating to signature blocks of the settlement agreement; and
during the online mediation session, automatically generating valid signature blocks for the settlement agreement using the user selected options.

15. A computer program product comprising computer readable instructions which, when loaded onto a computer, configures the computer to perform the method of claim 1.
